(19) United States
(12) Patent Application Publication
(10) Pub. No.: US 2010/0273343 A1
(43) Pub. Date: Oct. 28, 2010

(54) LAMP HOLDER CONNECTOR

(76) Inventor: CHIH KUO AI, Taipei Hsien (TW)

Correspondence Address: KILE PARK REED & MCMANUS, 1200 NEW HAMPSHIRE AVE, NW, SUITE 570, WASHINGTON, DC, 20036, US

(21) Appl. No.: 12/431,729

(22) Filed: Apr. 28, 2009

(51) Int. Cl. H01R 13/625

(52) U.S. Cl. 439/332

(57) ABSTRACT

A lamp holder connector includes: a first base provided with at least four curved fixing holes, each fixing hole having an insertion end and a fixing end; and a second base having a casing and at least four fixing pieces mounted on the casing. Each fixing piece is inserted into the insertion end of the fixing hole and engaged in the fixing end of the fixing hole, thereby the second base can be fixed to the first base.

### BACKGROUND OF THE INVENTION

1. Field of the Invention

The present invention relates to a lamp holder connector, and in particular, to a lamp holder connector having two sets of terminals for transmitting electricity and control signals.

2. Description of Related Art

Light-emitting diode (LED) has become a popular product for lighting. In order to increase the brightness of LED, it is an important issue to increase the efficiency of converting electricity into light. The light-emitting efficiency of a current LED is approximately 64% during a low-power condition. When the LED is used during a high-power condition, only 15-20% of inputted power is used to emit light, but more than 80% of inputted power is wasted in the form of heat generation. Unfortunately, the LED may suffer damage due to the generated heat. If the light-emitting elements cannot dissipate the generated heat, then the reliability of products may deteriorate due to different expansion coefficients from various packaging materials.

On the other hand, it is a technical bottleneck in the LED industry to control the light-emitting properties of LED. For example, the light-emitting performance of current LED is evaluated by two factors: “color temperature” and “color rendering index”. The color temperature means the color of light. The absolute temperature at which a standard light-emitting blackbody generates the same color as a light source is defined as the color temperature. The value of the color temperature may affect the atmosphere in a room. For example, a light source having a color temperature of 6000K or more is called a cool light source, and a light source having a color temperature of 2800K to 4000K is called a warm light source. Further, the color rendering index means percentage of vividness of an article's color sensed in a light source as compared to that sensed in sunshine. If the color rendering index is 100, it means the article's color sensed by eyes is the same as that sensed in sunshine. On the contrary, when a light source has a lower color rendering index, then the phenomenon of chromatic aberration in the sensed color is worsen.

However, there is no feasible solution to control the light-emitting properties of the LED. The conventional lamp holder is only provided with a set of terminals. The set of terminals are responsible for transmitting electricity and control signals. Thus, the light-emitting properties of LED are restricted and thus deteriorate.

Consequently, because of the above limitation resulting from the technical design of prior art, the inventor strives via real world experience and academic research to develop the present invention, which can effectively improve the limitations described above.

### SUMMARY OF THE INVENTION

The objective of the present invention is to provide a lamp holder connector having a male base and a female base that are assembled with each other. A fixing piece is used to fix the male base into the female base. The fixing piece is used to transmit electricity and signals, so that the light-emitting performance of the LED element can be improved.

To achieve the above-mentioned objective, the present invention provides a lamp holder connector, which includes: a first base provided with at least four curved fixing holes, each fixing hole having an insertion end and a fixing end; and a second base having a casing and at least four fixing pieces mounted on the casing, each fixing piece being inserted into the insertion end of the fixing hole and engaged in the fixing end of the fixing hole, whereby the second base can be fixed to the first base.

With the above arrangement, the second base can be rotated to allow the fixing piece to be engaged in the fixing hole of the first base, thereby achieving a better fixation. Furthermore, the fixing pieces can be used to transmit electricity and control signals, thereby controlling the light-emitting properties of LED more efficiently.

In order to further understand the techniques, means, and effects that the present invention takes for achieving the prescribed objectives, the following detailed descriptions and appended drawings are hereby referred; such that, through which the purposes, features, and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic view showing a LED being mounted in a lamp holder connector of the present invention;

FIG. 1A is a perspective view showing the LED being mounted in the lamp holder connector of the present invention;

FIG. 2 is a top view showing a first base of the lamp holder connector of the present invention;

FIG. 2A is a side view showing the first base of the lamp holder connector of the present invention;

FIG. 3 is a top view showing a second base of the lamp holder connector of the present invention;

FIG. 3A is a side view showing the second base of the lamp holder connector of the present invention;

FIG. 3B is a schematic view showing a fixing piece of the present invention; and

FIG. 4 is an exploded assembled view showing the lamp holder connector of the present invention.

### DETAILED DESCRIPTION OF THE PREFERRED EMBODIMENTS

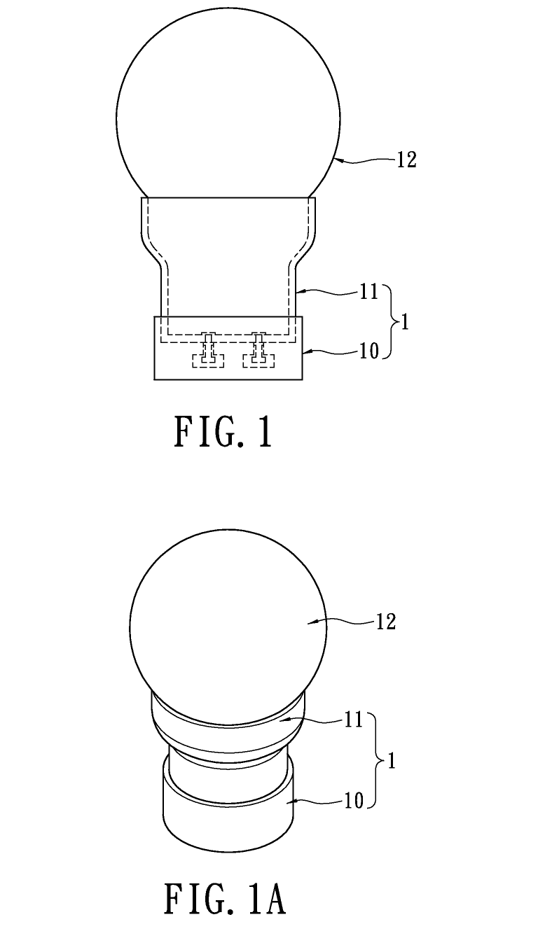

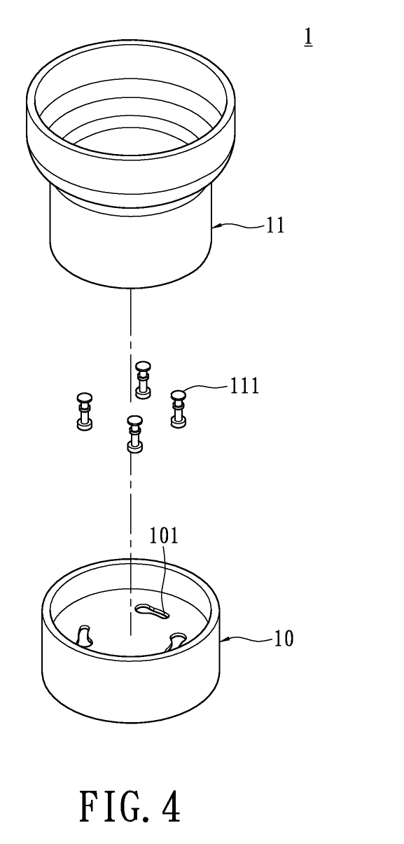

First, please refer to FIGS. 1 to 4. The present invention is to provide a lamp holder connector 1 that can be used as a lamp holder for a light-emitting diode (LED). The lamp holder connector 1 includes a first base 10 (i.e. female base) and a second base 11 (i.e. male base). The second base 11 can be engaged with the first base 10. The cooperation of the first base 10 with the second base 11 can allow a LED to be mounted therein. Further, the lamp holder connector 1 of the present invention can transmit electricity and control signals via different terminals, so that the LED can have a better light-emitting performance.

The first base 10 is provided with at least four curved fixing holes 101. Each fixing hole 101 includes an insertion end 1011 of a larger diameter and a fixing end 1012 of a smaller diameter. In other words, both ends of the fixing hole 101 are respectively the insertion end 1011 and the fixing end 1012. The fixing hole 101 has a curved profile.

On the other hand, the second base 11 is constituted of a casing 110 and at least four fixing pieces 111 mounted on the casing 110. Each of the fixing pieces 111 are respectively inserted into the insertion end 1011 of the fixing hole 101. The second base 11 can be rotated to allow each fixing piece 111 to be respectively engaged in the fixing end 1012 of the fixing hole 101. Via this arrangement, the second base 11 can be assembled with the first base 10 tightly. Further, the lamp holder connector 1 of the present invention has a control unit (not shown) for providing electricity and control signals. The control unit can be provided in the second base 11 or the first base 10. In other words, electric lines, the control unit, or other electronic elements can be mounted in the male base or the female base according to practical demands.

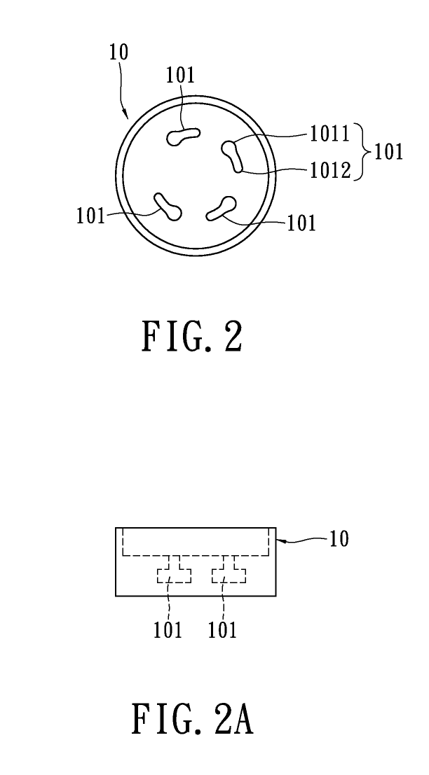

Please refer to FIGS. 1, 2, and 2A. In the present embodiment, the first base 10 is provided with four curved fixing holes 101. The second base 11 is provided with four fixing pieces 111 to correspond to the first base 10. Via the corresponding fixing holes 101 and fixing pieces 111, the second base 11 can be assembled with the first base 10.

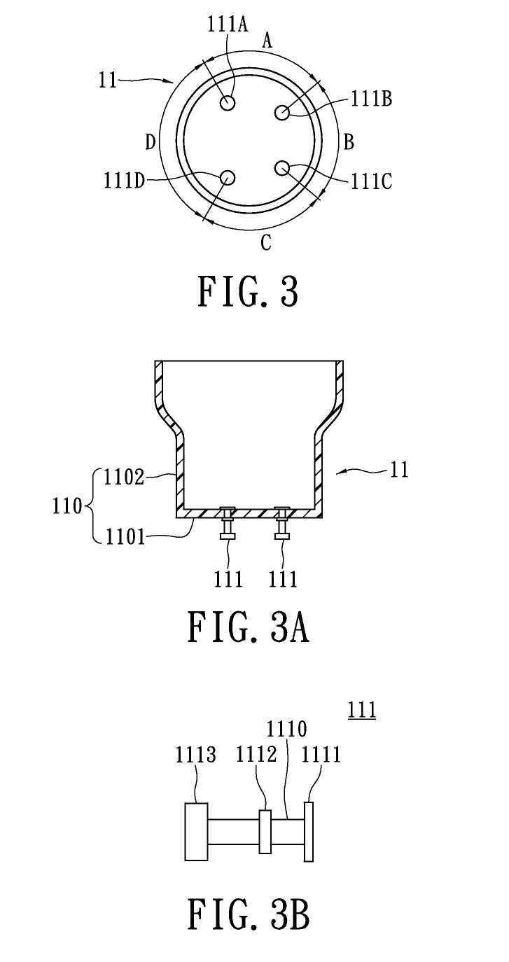

Please refer to FIGS. 3 and 3A. The casing 110 of the second base 11 is constituted of a bottom 1011 and a side 1102 that bents and extends from the bottom 1101. The bottom 1101 is provided with a first fixing piece 111A, a second fixing piece 111B, a third fixing piece 111C, and a four fixing piece 111D (these are the above-mentioned four fixing pieces 111). The four fixing pieces 111 are used to fix the second base 11 and the first base 10, and provide electricity and control signals necessary for the LED. In the present embodiment, the bottom 1101 is of a circular structure. The angle A between a radius formed by the center of the bottom 1101 passing through the first fixing piece 111A and a radius formed by the center of the bottom 1101 passing through the second fixing piece 111B is 80 degrees. The angle B between a radius formed by the center of the bottom 1101 passing through the second fixing piece 111B and a radius formed by the center of the bottom 1101 passing through the third fixing piece 111C is 80 degrees. The angle C between a radius formed by the center of the bottom 1101 passing through the third fixing piece 111C and a radius formed by the center of the bottom 1101 passing through the fourth fixing piece 111D is 80 degrees. The angle D between a radius formed by the center of the bottom 1101 passing through the fourth fixing piece 111D and a radius formed by the center of the bottom 1101 passing through the first fixing piece 111A is 120 degrees. With the above angles, the four fixing pieces 111 can be better engaged with the four fixing holes 101 of the first base 10. Briefly, when the four fixing pieces 111 are arranged in the above-mentioned angular relationship, they can be better engaged with the four fixing holes 101. The user can rotate the second base 11 easily, thereby each fixing piece 111 can be engaged with the fixing end 1012 of the corresponding fixing hole 101.

Further, the side 1102 of the casing 110 is formed into a cylindrical casing. The radius of the side 1102 can be adjusted according to practical demands. In the present invention, the radius of the side 1102 is expanded from the radius of the bottom 1101 to a larger radius. Via this arrangement, the LED can be mounted more easily.

On the other hand, please refer to FIG. 3B. Each fixing piece 111 includes a fixing body 1110 and a first locking arm 1111 extending from both sides of the fixing body 1110. The size of the first locking arm 1111 is slightly smaller than that of the insertion end 1011, but slightly larger than that of the fixing end 1012. Thus, the first locking arm 1111 can be inserted into the insertion end 1011. The fixing body 1110 of the fixing piece 111 can move along the fixing hole 101, so that the first locking arm 1111 can be engaged in the fixing end 1012. In this way, the second base 11 can be fixed to the first base 10.

Furthermore, each fixing piece 111 includes a second locking arm 1112 extending from both sides of the fixing body 1110 and a third locking arm 1113 extending from both sides of the fixing body 1110. In the present embodiment, each fixing piece 111 is fixed to the bottom 1101 of the casing 110 via the cooperation of the second locking arm 1112 and the second locking arm 1113. In other words, each locking piece 111 is provided on one side of the bottom 1101 of the casing 110 via the second locking arm 1112 and the third locking arm 1113. The fixing body 1110 of the fixing piece 111 is provided on the bottom 1101 of the casing 110. The distal end of the fixing body 1110 is provided with the first locking arm 1111.

Via the above arrangement, the second base 11 of the present invention can be mounted in the first base 10. The fixing piece 111 protruding from the second base 11 can be inserted into the fixing hole 101 of the first base 10. The first locking arm 1111 of the fixing piece 111 is hooked to the fixing end 1012 of the fixing hole 101, so that the second base 11 can be tightly mounted in the first base 10.

Furthermore, when the LED element 12 is mounted in the lamp holder connector 1, the LED element 12 is brought into contact with the four fixing pieces 111 within the second base 11. The four fixing pieces 111 provide two sets of different forms of transmission. One set of the fixing pieces 111 are used to transmit the electricity necessary for the LED element 12, and the other set of fixing pieces 111 are used to transmit the control signals for controlling the LED element 12 so as to control the light-emitting conditions of the LED element 12 (such as the color temperature of the LED element 12). In other words, these fixing pieces 111 also serve as terminals for transmitting electricity and signals.

According to the above, the present invention has advantageous features as follows.

(I) The lamp holder connector 1 of the present invention has a better light-emitting performance. The lamp holder connector 1 can provide two sets of terminals (i.e. the above four fixing pieces 111) to transmit electricity and control signals respectively. Thus, the LED element 12 mounted in the lamp holder connector 1 can have a better light-emitting performance.

(II) In the present invention, the second base 11 and the first base 10 can be assembled with each other via hooks, thereby preventing the detachment of the two bases. Alternatively, the second base 11 can be rotated and thus mounted in the first base 10. Thus, the assembly is easy.

The above-mentioned descriptions represent merely the preferred embodiment of the present invention, without any intention to limit the scope of the present invention thereto. Various equivalent changes, alternations, or modifications based on the claims of present invention are all consequently viewed as being embraced by the scope of the present invention.

What is claimed is:

1. A lamp holder connector, comprising:
a first base provided with at least four curved fixing holes, each fixing hole having an insertion end and a fixing end; and
a second base having a casing and at least four fixing pieces mounted on the casing, wherein each fixing piece is inserted into the insertion end of the fixing hole and engaged in the fixing end of the fixing hole, thereby fixing the second base to the first base.

2. The lamp holder connector according to claim 1, wherein the casing comprises a bottom and a side that bents and extends from the bottom, the second base comprises a first fixing piece provided on the bottom, a second fixing piece provided on the bottom, a third fixing piece provided on the bottom, and a fourth fixing piece provided on the bottom.

3. The lamp holder connector according to claim 2, wherein the bottom is of a circular structure, the angle between a radius formed by the center of the bottom passing through the first fixing piece and a radius formed by the center of the bottom passing through the second fixing piece is 80 degrees, the angle between a radius formed by the center of the bottom passing through the second fixing piece and a radius formed by the center of the bottom passing through the third fixing piece is 80 degrees, and the angle between a radius formed by the center of the bottom passing through the third fixing piece and a radius formed by the center of the bottom passing through the fourth fixing piece is 80 degrees

4. The lamp holder connector according to claim 3, wherein two of the first fixing piece, the second fixing piece, the third fixing piece, and the fourth fixing piece are used to transmit electricity, and the other two fixing pieces are used to transmit control signals.

5. The lamp holder connector according to claim 4, wherein the lamp holder connector allows a light-emitting diode element to be mounted therein.

6. The lamp holder connector according to claim 1, wherein the insertion end and the fixing end are located on both ends of the fixing hole, the diameter of the insertion end is larger than that of the fixing end.

7. The lamp holder connector according to claim 6, wherein each fixing piece further comprises a fixing body and a first locking arm extending from both sides of the fixing body, the first locking arm passes through the insertion end, the fixing piece moves along the fixing hole to allow the first locking arm to be engaged in the fixing end.

8. The lamp holder connector according to claim 7, wherein each fixing piece further comprises a second locking arm extending from both sides of the fixing body and a third locking arm extending from both sides of the fixing body, each fixing piece is fixed to the casing via the second locking arm and the third locking arm.
